(19) United States
(12) Patent Application Publication
(10) Pub. No.: US 2026/0205831 A1
(43) Pub. Date: Jul. 16, 2026

(54) COORDINATION OF MULTIPLE SERVICE NODES

(71) Applicant: ZTE CORPORATION, Shenzhen, Guangdong (CN)

(72) Inventors: Li YANG, Shenzhen (CN); Yan XUE, Shenzhen (CN); Fei WANG, Shenzhen (CN); Feng XIE, Shenzhen (CN)

(21) Appl. No.: 19/134,287

(22) PCT Filed: Jun. 30, 2023
(86) PCT No.: PCT/CN2023/104935

§ 371 Date: May 30, 2025

(51) Int. Cl. H04W 24/02; H04W 4/50

(52) U.S. Cl. CPC H04W 24/02; H04W 4/50

(57) ABSTRACT

A control plane (CP) entity manages and coordinates multiple service nodes for multiple types of services. The services include a communication service, computing service, intelligence service, storage service, and/or security service. The CP entity configures extended user plane (UP) functions that support multiple services and initiates execution of those functions based on the configuration. The UP entity reports the capabilities for multiple services within the UP entity and receives a configuration(s) for the supported multiple services. The UP function is initiated and executed based on the received UP configuration from the CP entity.

### CROSS REFERENCE

This disclosure is a national stage filing under 35 U.S.C. § 371 of international application number PCT/CN2023/104935, filed Jun. 30, 2023, the entire contents of which are incorporated herein by reference.

### TECHNICAL FIELD

This document is directed generally to wireless communications. More specifically, a user plane (UP) entity supports multiple services as configured.

### BACKGROUND

Wireless communication technologies are moving the world toward an increasingly connected and networked society. Wireless communications rely on efficient network resource management and allocation between user mobile stations and wireless access network nodes (including but not limited to radio access network (“RAN”) nodes and wireless basestations). A new generation network is expected to provide high speed, low latency and ultra-reliable communication capabilities and fulfil the requirements from different industries and users. User mobile stations or user equipment (“UE”) are becoming more complex and the amount of data communicated continually increases. With the development of more advanced radar and sensing systems, communications between with the UE can be modernized.

### SUMMARY

This document relates to methods, systems, and devices for a control plane (CP) entity that manages and coordinates multiple service nodes for multiple types of services. The services at least include a communication service, computing service, intelligence service, storage service, and/or security service. The CP entity configures the extended user plane (UP) functions that support multiple services and initiates the execution of those functions based on the configuration. The UP entity reports the capabilities for multiple services within the UP entity and receives a configuration(s) for the supported multiple services. The UP function is initiated and executed based on the received UP configuration from the CP entity.

In one embodiment, a method for wireless communication includes configuring the extended user plane (UP) functions that support multiple services; and initiating the execution of UP functions based on the configuring towards UP entity. The UP functions comprise identifying a service type, UP task identification, and executing the functions for multiple service(s) based on the UP configuration(s). The multiple services comprises at least two of a communication service, computing service, intelligence service, storage service, and/or security service services. The configuring and the transmitting of UP configuration(s) is by network entity that comprises a control plane (CP) entity. The UP configuration(s) is received at the UP entity from the CP entity. The configuring is through internal signaling or interface based signaling. The configuring comprises UP configuration(s) of multiple services for one or multiple user plane (UP) entities. The method includes synchronizing and coordinating the multiple services across the multiple UP entities. The method includes allocating a task identification for the synchronizing and coordinating the multiple services across the multiple UP entities. The multiple UP entities are configured to exchange service data for different service types through different data transfer tunnels between the multiple UP entities. The UP entity reports and updates a status or result for execution of the task(s) with the CP entity through internal signaling or an interface based signaling procedure.

In another embodiment, a method for wireless communication includes reporting the capabilities for multiple services within user plane (UP) entity; and receiving an UP configuration(s) for the supported multiple services. The UP functions comprise identifying a service type, UP task identification, and executing functions for the multiple service(s) based on the UP configuration(s). The multiple services comprises at least two of a communication service, computing service, intelligence service, storage service, and/or security service services. The reporting of capabilities and the receiving of UP configuration(s) is by network entity that comprises one or more user plane (UP) entities. The UP configuration is from a control plane (CP) entity, wherein the UP configuration is received at the one or more UP entities from the CP entity. The UP configuration is through internal signaling or interface based signaling. The UP configuration(s) comprises the separate UP configuration of each service to be configured for one or more user plane (UP) entities. The UP configuration(s) comprises a synchronization and coordinating of the multiple services for one or more UP entities. The UP configuration(s) comprises a task identification for the synchronization and coordinating of the multiple services across the one or more UP entities. The one or more UP entities are configured to exchange service data for different service types through different data transfer tunnels between the one or more UP entities. The UP entity reports and updates a status or result for execution of the task(s) with the CP entity through internal signaling or an interface based signaling procedure.

In another embodiment, a wireless communications apparatus includes a processor and a memory, wherein the processor is configured to read code from the memory and implement any method recited herein.

In another embodiment, a computer program product includes a computer-readable program medium code stored thereupon, the code, when executed by a processor, causing the processor to implement any method recited herein.

In some embodiments, there is a wireless communications apparatus comprising a processor and a memory, wherein the processor is configured to read code from the memory and implement any methods recited in any of the embodiments. In some embodiments, a computer program product comprising a computer-readable program medium code stored thereupon, the code, when executed by a processor, causing the processor to implement any method recited in any of the embodiments. The above and other aspects and their implementations are described in greater detail in the drawings, the descriptions, and the claims.

### BRIEF DESCRIPTION OF THE DRAWINGS

FIG. 1 shows an example basestation.

FIG. 2 shows an example random access (RA) messaging environment.

FIG. 3 shows a single connectivity wireless communication system.

FIG. 4 shows a split case single connectivity wireless communication system.

FIG. 5 shows an embodiment of a wireless network system architecture.

FIG. 6 shows user plane (UP) processing and data forwarding.

FIG. 7 shows a single basestation system diagram with extended user plane (UP) functions supporting multiple services.

FIG. 8 shows a dual basestation system diagram with extended user plane (UP) functions supporting multiple services.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

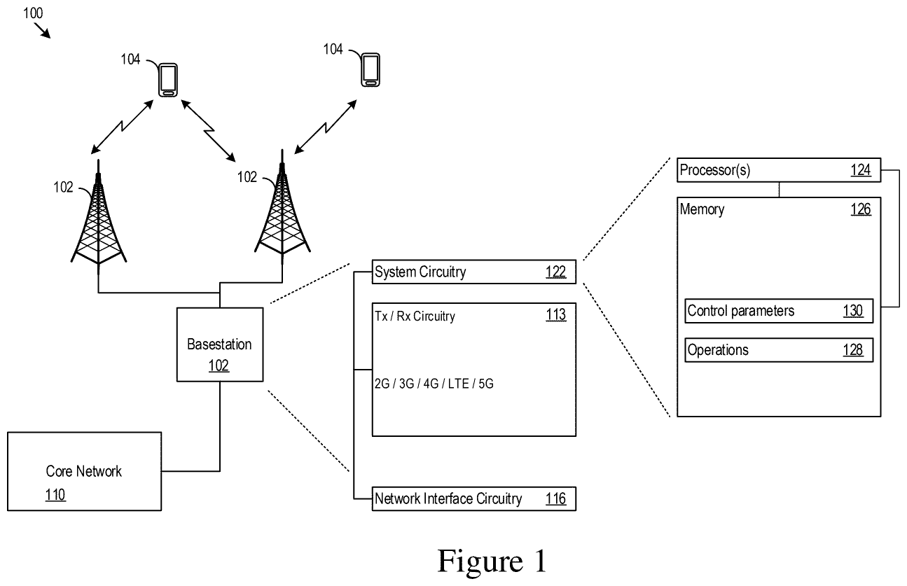

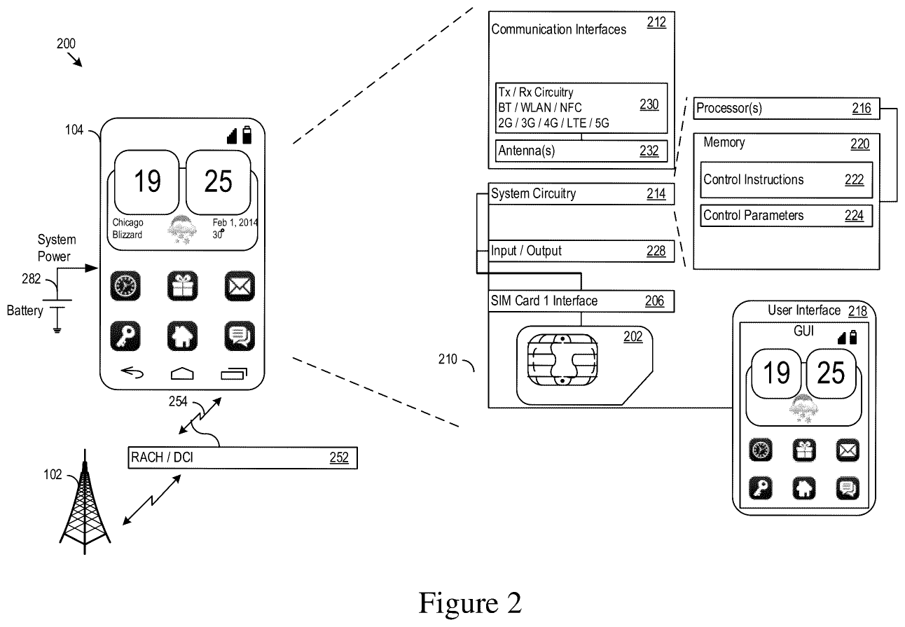

Radio resource control (“RRC”) is a protocol layer between UE and the basestation at the IP level (Radio Network Layer). There may be various Radio Resource Control (RRC) states, such as RRC connected (RRC_CONNECTED), RRC inactive (RRC_INACTIVE), and RRC idle (RRC_IDLE) state. RRC messages are transported via the Packet Data Convergence Protocol (“PDCP”). UE can transmit infrequent (periodic and/or non-periodic) data in RRC_INACTIVE state without moving to an RRC_CONECTED state. This can save the UE power consumption and signaling overhead. This can be through a Random Access Channel (“RACH”) protocol scheme or a Configured Grant (“CG”) scheme.—The wireless communications described herein may be through radio access. FIGS. 1-2 show example radio access network (“RAN”) nodes (e.g. basestations) and user equipment and messaging environments, which may be applicable the user plane (UP) functions and communications described below.

With the latest development of wireless communication systems (e.g. 5G-NR and 6G wireless systems) along with various distributed computing, intelligence, storage, and security systems, integration may be a challenge. Integration with each other may be in terms of architecture or capability, or network and air interface resource usages, etc. The 5G-Advanced (5G-A) and 6G wireless systems may attempt to integrate various new functions and services with legacy systems, including but not limited to computing services, intelligence services, storage services, and/or security systems. As a result, core network (CN) and RAN nodes may not only provide wireless communication service, but also provide computing services, intelligence services, storage services, and/or security services, etc.

User plane (UP) functions in a single service wireless communication node may only be targeted for processing, transferring, and/or forwarding user data associated to different users' mobile services, such as mobile APP and Web services. The single service may be referred to as a communication service. A corresponding control plane (CP) entity may provide the UP setting and configurations to the UP entity. The UP entity follows the rules and configurations instructed by the CP entity. The UP entity may have multiple service capabilities and be able to handle additional UP functions as described below. Example services include a communication service, computing service, intelligence service, storage service, and/or security service. These services may be associated with different functions and services. As described below, the CP entity can coordinate multiple service nodes for those multiple service types.

FIG. 1 shows an example (“RAN”) node or basestation 102. The RAN node may also be referred to as a wireless network node. The RAN node 102 may be further identified to as a nodeB (NB, e.g., an eNB or gNB) in a mobile telecommunications context. The example RAN node may include radio Tx/Rx circuitry 113 to receive and transmit with user equipment (UEs) 104. The RAN node may also include network interface circuitry 116 to couple the RAN node to the core network 110, e.g., optical or wireline interconnects, Ethernet, and/or other data transmission mediums/protocols.

The RAN node may also include system circuitry 122. System circuitry 122 may include processor(s) 124 and/or memory 126. Memory 126 may include operations 128 and control parameters 130. Operations 128 may include instructions for execution on one or more of the processors 124 to support the functioning the RAN node. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

FIG. 2 shows an example random access messaging environment 200. In the random access messaging environment a UE 104 may communicate with a RAN node 102 over a random access channel 252. In this example, the UE 104 supports one or more Subscriber Identity Modules (SIMs), such as the SIM1 202. Electrical and physical interface 206 connects SIM1 202 to the rest of the user equipment hardware, for example, through the system bus 210.

The mobile device 200 includes communication interfaces 212, system logic 214, and a user interface 218. The system logic 214 may include any combination of hardware, software, firmware, or other logic. The system logic 214 may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the inputs 228 may include a graphical user interface, touch sensitive display, haptic feedback or other haptic output, voice or facial recognition inputs, buttons, switches, speakers and other user interface elements. Additional examples of the inputs 228 include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data 226 that the UE 104 will send, or has received, through the communication interfaces 212. In various implementations, the system power may be supplied by a power storage device, such as a battery 282.

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA)+, and 4G/Long Term Evolution (LTE) standards. The techniques described below, however, are applicable to other wireless communications technologies whether arising from the 3rd Generation Partnership Project (3GPP), GSM Association, 3GPP2, IEEE, or other partnerships or standards bodies.

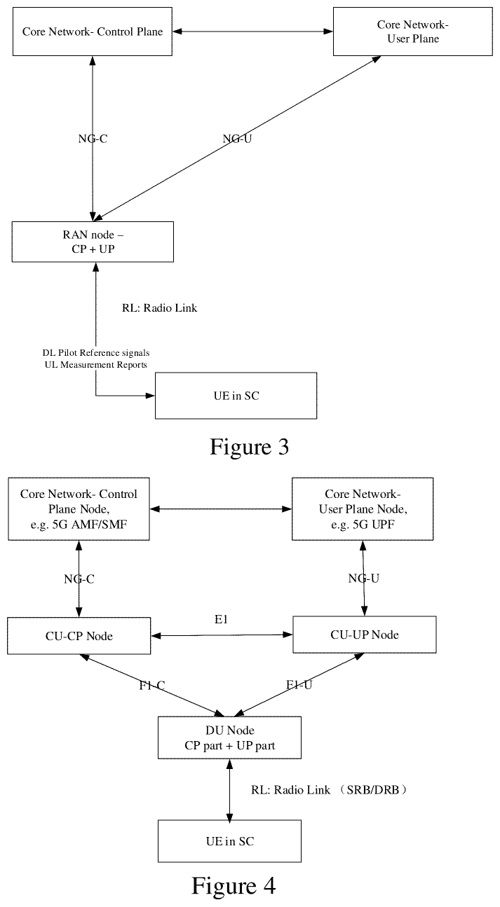

FIG. 3 shows a single connectivity wireless communication system. Single connectivity (SC) may include a UE that only has a master radio link (M-RL) but no radio links on the secondary RAN node side. Conversely, dual connectivity (DC) includes a UE with a secondary communication radio link (S-RL) on the secondary RAN node side. In IMT wireless communication systems (such as 4G-LTE and 5G-NR) as shown in FIG. 3, the Radio Access Network (RAN) node may transmit downlink (DL) pilot reference signals such as SSB, CSI-RS, etc. The UE receives, measures and processes them so that UE can know the connection quality of radio link (RL) over the air. This may be the communications between the serving RAN node and UE, in order to maintain the communication service continuity. This is an example with single connectivity (SC).

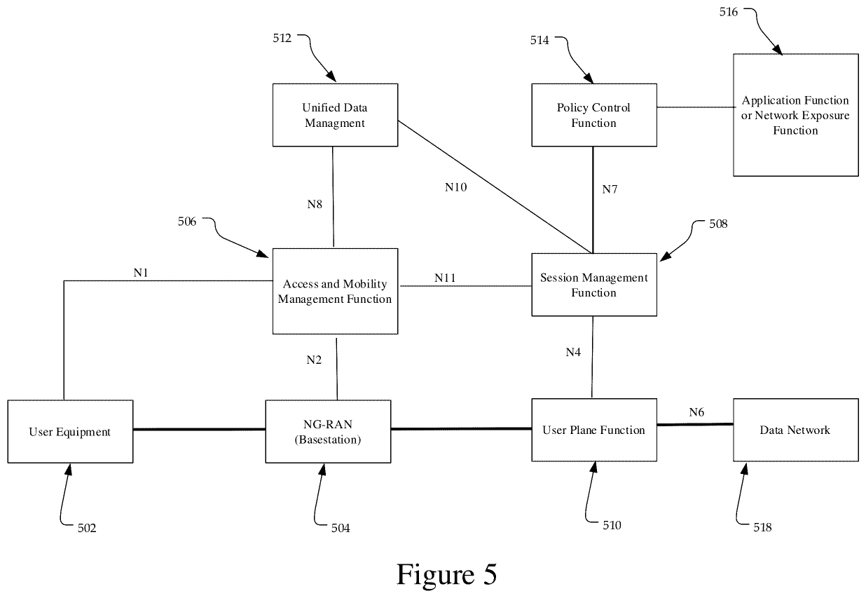

FIG. 4 shows a split case single connectivity wireless communication system. FIG. 3 shows a non-split case, while FIG. 4 illustrates a split of CU-CP node and CU-UP node. In IMT wireless communication systems (such as 5G-NR specified by 3GPP) as shown in FIGS. 3-4, the Core Network (CN) may include various types of control plane (CP) nodes or entities (e.g. 5G AMF/SMF), and a user plane (UP) node or entity (e.g. 5G UPF). In the RAN non-split case in FIG. 3, the RAN node (e.g. 5G aggregated basestation) includes a CP part and UP part, and then terminates on UE via a radio link (RL) in the air. In the RAN split case of FIG. 4, the RAN node (e.g. 5G dis-aggregated basestation) includes a CU-CP node, CU-UP node, and DU node or entities, and then terminates on UE via RL in the air. The CP part or node may be responsible for generating, processing, and transferring control signaling (e.g. for (re) configuring and monitoring other nodes). The UP part or node is responsible for processing and transferring user data (e.g. associated to mobile APP and Web services, etc.). For both the CP and UP plane, there may be a separate interface and protocol stack and normally spans from CN domain to RAN network and then to UE. The UP functions are further described below and can be implemented in the systems shown in FIGS. 1-2 or in the system of FIG. 5 described below.

FIG. 5 shows an embodiment of a wireless network system architecture. This architecture is merely one example and there may be more or fewer components for implementing the embodiments described herein. The interconnections or communications between components are identified as N1, N2, N4, N6, N7, N8, N10, and N11, which may be referred to in the description or by other Figures. FIG. 2 illustrated an example user equipment (“UE”) 104. UE 502 is a device accessing a wireless network (e.g. 5GS) and obtaining service via a NG-RAN node or basestation 504. The UE 502 interacts with an Access and Mobility Control Function (“AMF”) 506 of the core network via NAS signaling. FIG. 1 illustrates an example basestation or NG-RAN 102. The NG-RAN node 504 is responsible for the air interface resource scheduling and air interface connection management of the network to which the UE accesses. The AMF 506 includes the following functionalities: Registration management, Connection management, Reachability management and Mobility Management. The AMF 506 also perform the access authentication and access authorization. The AMF 506 is the NAS security termination and relay the session management NAS between the UE 502 and the SMF 508, etc.

The SMF 508 includes the following functionalities: Session Management e.g. Session establishment, modify and release, UE IP address allocation & management (including optional Authorization), Selection and control of uplink function, downlink data notification, etc. The user plane function (“UPF”) 510 includes the following functionalities: Anchor point for Intra-/Inter-RAT mobility, Packet routing & forwarding, Traffic usage reporting, QoS handling for user plane, downlink packet buffering and downlink data notification triggering, etc. The Unified Data Management (“UDM”) 512 manages the subscription profile for the UEs. The subscription includes the data used for mobility management (e.g. restricted area), session management (e.g. QoS profile). The subscription data also includes slice selection parameters, which are used for AMF 506 to select a proper SMF 508. The AMF 506 and SMF 508 get the subscription from the UDM 512. The subscription data may be stored in a Unified Data Repository with the UDM 512, which uses such data upon reception of request from AMF 506 or SMF 508. The Policy Control Function (“PCF”) 514 includes the following functionality: supporting unified policy framework to govern network behavior, providing policy rules to control plane function(s) to enforce the policy rule, and implementing a front end to access subscription information relevant for policy decisions in the User Data Repository. The Network Exposure Function (“NEF”) 516 is deployed optionally for exchanging information with an external third party. In one embodiment, an Application Function (“AF”) 516 may store the application information in the Unified Data Repository via NEF. The UPF 510 communicates with the data network 518.

Access Mobility Function (“AMF”) and Session Management Function (“SMF”) are the control plane entities and User Plane Function (“UPF”) is the user plane entity in new radio (“NR”) or 5GC. The signaling connection between AMF/SMF and MN may be a Next Generation-Control Plane (“NG-C”)/MN interface. The signaling connection between MN and SN may be an Xn-Control Plane (“Xn-C”) interface. The signaling connection between MN and UE may be a Uu-Control Plane (“Uu-C”) RRC interface. As described below, there may be additional components or entities for UP processing and data forwarding functions.

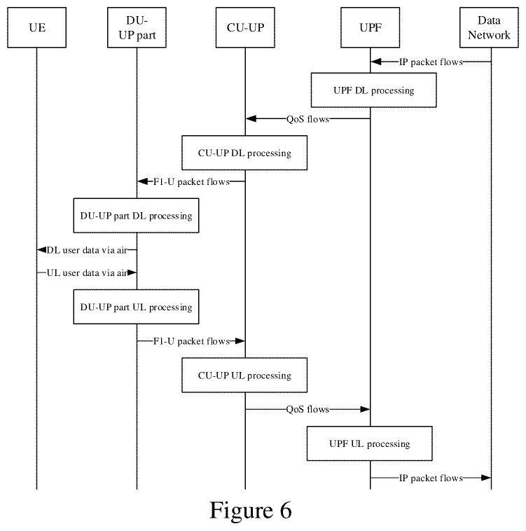

FIG. 6 shows user plane (UP) processing and data forwarding in one example. For either UP part integrated in the network node or the UP node as a separate network node, it may be (re) configured by the CP part or CP node, with UP processing strategies and various protocol parameters. Once the UP part or UP node obtains the input user data (i.e. DL/UL packet flows), it processes them accordingly based on CP configurations, and then outputs/forwards them to the next UP part or UP node in sequence. Without the additional functions, in the legacy wireless communication systems (such as 4G-LTE and 5G-NR), the user data may be always terminated on either particular UE in DL direction or data network server in UL direction, so it is always an end to end (E2E) communication service that serves for only transferring user data. The mechanism for UP processing and data forwarding is shown in FIG. 6. In the embodiments below, there are additional functions/services for coordinating multiple service nodes.

In some embodiments, the intermediate network node or entity (e.g. 5G UPF, CU-UP and DU-UP part) are only used for end to end (E2E) communication service, and/or for transferring/forwarding user data of the UE in the downlink (DL) or uplink (UL) direction. Coordination of the control plane (CP) entity can provide for additional support for multiple services. There may be different implementations, including some internal and different levels of computing service, intelligence service, storage service, and/or security service handling/behaviors, including DPI, packet compressing, packet encryption, and artificial intelligence (training, inferring, etc.). Each of those computing service, intelligence service, storage service, and/or security service handling or behaviors may not be controlled by the CP entity without providing a configuration as described herein. The CP entity can manage, orchestrate, or control the multiple types of services conducted or executed by either one UP entity or multiple UP entities. The CP entity can coordinate the split work and processing belonging to multiple types of services between/among several UP entities efficiently. The coordinating is implemented in a CP entity to be resource efficient and QoE friendly, without enabling high qualified multi-service provision.

### Multiple Services Coordination

As mentioned, a control plane (CP) entity that manages and coordinates multiple service nodes for multiple types of services. The services at least include a communication service, computing service, intelligence service, storage service, and/or security service. The CP entity configures the extended user plane (UP) functions that support multiple services and initiates the execution of those functions based on the configuration. The UP entity reports the capabilities for multiple services within the UP entity and receives a configuration(s) for the supported multiple services. The UP function is initiated and executed based on the received UP configuration from the CP entity.

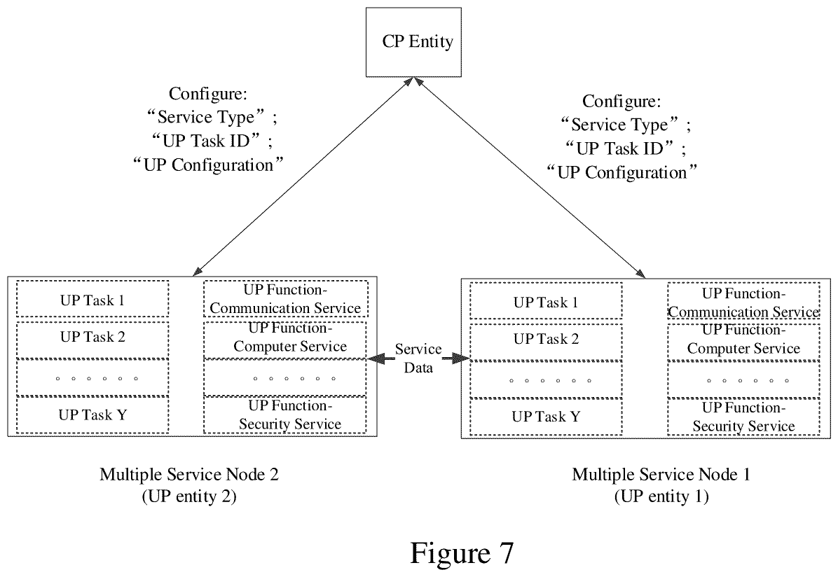

FIG. 7 shows a single basestation system diagram with extended user plane (UP) functions supporting multiple services. This diagram is a centralized model for coordination of multiple service nodes. The single basestation has a single CP entity in one embodiment. While the CP entity and UP entity are shown separately, they may be together physically. There may be several blocks in UP entity including other functions or configurations. A legacy UP entity (only for communication) may not have the functions/services shown here. The CP entity may configure and coordinate the multiple service nodes. The CP entity coordinates/controls handling over different entities. Services can be synchronized over multiple UP entities. As described below, there is a UP task identification that is allocated by the CP and used to control synchronization across UP entities. While service handling had previously been invisible to the CP entity, the UP configuration (may be referred to as “generalized UP configuration”) may allow the CP to manage and configure the multiple services.

The following are relevant terms for coordination of multiple service nodes:
“CP entity”: refers to control plane (CP) part integrated in certain network node or dedicated CP node as a separate network node.
“UP entity”: refers to user plane (UP) part integrated in certain network node or dedicated UP node as separate network node.
“Multiple Services”: refers to additional services provided by a (wireless) network system, including but not limited to a communication service, computing service, intelligence service, storage service, and/or security service services.
“Communication Service Data”: user data generated by either data network server or UE, associated to certain E2E communication services.
“Computing Service Data”: intermediate data generated by any network node, associated to certain computing services.
“Intelligence Service Data”: intermediate data generated by any network node, associated to certain Intelligence services.
“Storage Service Data”: intermediate data generated by any network node, associated to certain storage services.
“Security Service Data”: intermediate data generated by any network node, associated to certain security services.
“Multiple Service Node”: network node capable of multiple types of services other than the legacy E2E communication service alone. It may support at least two types of services among at least communication service, computing service, intelligence service, storage service, and/or security service services, etc.
“Service Type”: at least refers to additional services, including but not limited to: communication, computing, Intelligence, storage, and security services supported by the network.
“Generalized UP functions”: refers to data/packet processing associated with multiple services, including at least a communication service, computing service, intelligence service, storage service, and/or security service services. The legacy UP function only refers to the data/packet processing associated to the E2E communication service.
“Generalized UP Configuration”: refers the setting and configurations for “generalized UP functions”, including at least: “Service Type” and various services related UP setting and parameters, including:
   UP parameters set for a communication service, such as source/target IP/Port address, data transfer bandwidth, latency limitation requirement, etc.;
   UP parameters set for a computing service, such as computing resource type/address, computing resource amount, latency limitation requirement, etc.;
   UP parameters set for an intelligence service, such as artificial intelligence (AI)/machine learning (ML) mode, algorithm, or model etc.;
   UP parameters set for a storage service, such as storage resource type/address, storage resource amount, etc.;
   UP parameters set for a security service, such as security mode, algorithm, or model etc.

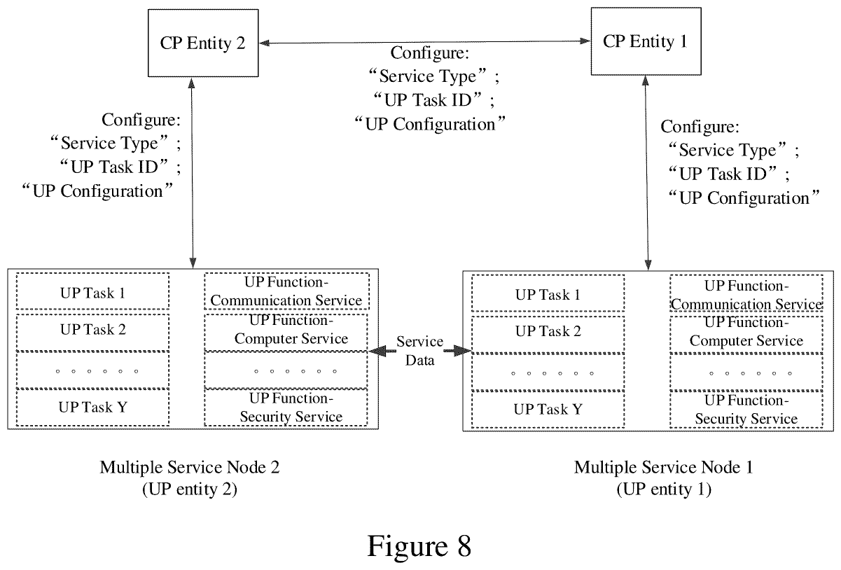

FIG. 8 shows a dual basestation system diagram with extended user plane (UP) functions supporting multiple services. Different from FIG. 7, this diagram is a decentralized model. As shown, there may be two separate basestations, each with one CP entity. In this example, there may be Xn signaling between CP entities. For the split basestation, the CP entity and UP entity may be physically separate. There may be several blocks in UP entity including other functions or configurations. A legacy UP entity (only for communication) may not have the functions/services shown here. Services can be synchronized over multiple UP entities. As described below, there is a UP task identification that is allocated by the CP and used to control synchronization across UP entities. While service handling had previously been invisible to the CP entity, the UP configuration (may be referred to as “generalized UP configuration”) may allow the CP to manage and configure the multiple services.

Referring to either FIG. 7 or FIG. 8, the following are features of the coordination of multiple service nodes. The UP entity in a multiple service node can report and update its actual multiple service capabilities with the connected/controlled CP entity via internal signaling or interface based signaling procedure. The CP entity then knows the actual/real capabilities of each connected multiple service node. The interface based signaling procedure may include an RRC procedure, NAS procedure, NGAP procedure, XnAP procedure, F1AP procedure, E1AP procedure or potentially newly specified interface procedure. The multiple service capabilities supported by the UP entity include at least a communication service, computing service, intelligence service, storage service, and/or security service services. There may be a detailed capability information for each type of service.

The CP entity can assign and configure one or more UP entities with a list (number of UP tasks) of parameters, such as UP Task identification, Service Type and UP Configuration (or generalized UP configuration) via internal signaling or via an interface based signaling procedure. The content of the UP Task identification may be an index id, which refers to particular UP task assigned by the CP entity. The UP Task identification may be used to trace/link/associate the same UP task to be executed across different UP entities. The content of Service Type may include an index id or explicit indications. The meaning of each index id or indication may be predefined by specifications.

The UP Configuration is configured by the CP entity and is adapted to different types of services and related tasks, including at least a communication service, computing service, intelligence service, storage service, and/or security service services and their related UP tasks. The UP Configuration (or generalized UP configuration) may include:
UP parameters set for a communication service, such as source/target IP/Port address, data transfer bandwidth, latency limitation requirement, etc.;
UP parameters set for a computing service, such as computing resource type/address, computing resource amount, latency limitation requirement, etc.;
UP parameters set for an intelligence service, such as artificial intelligence (AI)/machine learning (ML) mode, algorithm, or model etc.;
UP parameters set for a storage service, such as storage resource type/address, storage resource amount, etc.;
UP parameters set for a security service, such as security mode, algorithm, or model etc.

The interface based signaling procedure may at least include a RRC procedure, NAS procedure, NGAP procedure, XnAP procedure, F1AP procedure, E1AP procedure or potentially newly specified interface procedure. Upon being assigned and configured by the CP entity, the UP entity in the multiple service node performs or executes the corresponding UP tasks related to different types of service as configured. The UP entity can perform or execute the corresponding multiple UP tasks either in parallel simultaneously or in the indicated order/sequence. The UP entity can report and update its actual UP tasks' executing progress/status/result with the CP entity via internal signaling or interface based signaling procedure. In this way, the CP entity knows the actual progress/status/result of each UP task executed by the UP entity. The two neighbor CP entities can coordinate the list of parameters such as UP Task identification, Service Type, and UP Configuration via interface based signaling procedure. The two neighbor UP entities can exchange different types of service data (such as data for communication service, computing service, intelligence service, storage service, and/or security service services) when necessary via a data/packet transfer tunnels in-between the UP entities.

As described and shown in FIGS. 7-8, the configuration may include the Service Type, UP task identification, and/or the UP configuration (i.e. generalized UP configuration). These are merely examples of potential configuration parameters and there may be more or fewer parameters. Because of the configurability provided, any of those types/modes can be varied. Below are example embodiments that describe particular combinations of those configurable parameters. These are merely examples and many other combinations are possible in other examples.

In a first example embodiment as in FIG. 7, the CU entity communicates via the E1AP signaling procedure with two UP entities. For this example, the UP task identifications are configured with a service type of communication service for UP task identification 1 and a service type of computing service for UP task identification 2. This is merely one example of the parameters that can configured. UP entity 1 and UP entity 2 are both capable of performing or executing UP tasks of communication and computing service type (e.g. both UP entities can transfer user data and execute particular DPI operation with the incoming packets from upper-stream node UPF). Due to lack of computing resources locally or in order to obtain better DPI analyzing results, the CP entity can let UP entity 1 and UP entity 2 perform the computing UP task jointly (e.g. UP entity 1 performs DPI operation with some of the “odd number” QoS Flow packets and UP entity 2 performs DPI operation with some of the “even number” QoS Flow packets). UP entity 1 and UP entity 2 perform the communication UP task jointly in parallel (e.g. they exchange/transfer the QoS Flow packets of user data from UPF).

As the controlling/coordinating node, the CP entity assigns and configures the UP entity 1 and UP entity 2 individually via E1AP signaling procedure. It may include the following parameters for two UP tasks of different service types including:
{UP Task id=1, Service Type=communication, transfer user data, UP parameters set for communication service};
{UP Task id=2, Service Type=computing, DPI operation, UP parameters set for computing service}.

Upon assignment and configuration by the CP entity, the UP entity 1 and UP entity 2 determine how/when to perform the communication UP task 1 and computing UP task 2 as indicated by the CP entity. UP entity 1 may establish a “Data Transfer Tunnel 1” when necessary for exchanging Communication Service Data of UP task 1 with the neighbor UP entity 2. UP entity 1 may establish a “Data Transfer Tunnel 2” when necessary for exchanging Computing Service Data of UP task 2 with the neighbor UP entity 2. UP entity 1 and UP entity 2 jointly perform the communication UP task 1 according to the configuration of UP parameters set for communication service, and may exchange the Communication Service Data of UP task 1 via the “Data Transfer Tunnel 1.” The UP entity 1 and UP entity 2 jointly perform the computing UP task 2 according to the configuration of UP parameters set for computing service, and may exchange the Computing Service Data of UP task 2 via the “Data Transfer Tunnel 2.” Afterwards during the execution of two UP tasks, UP entity 1 and UP entity 2 can individually report and update the progress/status/result of UP task 1 or UP task 2 with the CP entity via E1AP signaling procedure. The CP entity may also reconfigure the UP entity 1 and UP entity 2 individually when necessary.

In a second example embodiment, there may be multiple CU entities as in FIG. 8. This is different from embodiment 1 because of the multiple CU entities and because of the different UP task identifications and services. The two CU entities communicate with each other via an Xn interface. For this example, the UP task identifications are configured with a service type of communication service for UP task identification 3 and a service type of computing service for UP task identification 4. This is merely one example of the parameters that can configured. UP entity 1 and UP entity 2 are both capable of performing or executing UP tasks of communication and computing service type (e.g. both UP entities can transfer user data and execute particular DPI operation with the incoming packets from upper-stream node UPF). As shown, CP entity 1 is connecting with UP entity 1, and CP entity 2 is connecting with UP entity 2. The two neighbor CP entity 1 and CP entity 2 are connected via an Xn interface. The UP entity 1 and UP entity 2 are both capable of performing or executing UP tasks of communication and computing service type (e.g. both UP entities can transfer user data and execute particular DPI operation with the incoming packets from upper-stream node UPF). Due to lack of computing resources locally or in order to obtain better DPI analyzing results, CP entity 1 may let UP entity 1 and UP entity 2 perform the computing UP task jointly (e.g. UP entity 1 performs DPI operation with some of the “odd number” QoS Flow packets and UP entity 2 performs DPI operation with some of the “even number” QoS Flow packets). UP entity 1 and UP entity 2 may perform the communication UP task jointly in parallel (e.g. they exchange/transfer the QoS Flow packets of user data from UPF).

As the primary coordinating/controlling node, CP entity 1 assigns and configures the UP entity 1 via E1AP signaling procedure. CP entity 1 further assigns and configures the neighbor CP entity 2 via XnAP signaling procedure. CP entity 2 further assigns and configures the UP entity 2 via E1AP signaling procedure. All of these signaling procedures may include the following parameters for two UP tasks of different service types:
{UP Task id=3, Service Type=communication, transfer user data, UP parameters set for communication service};
{UP Task id=4, Service Type=computing, DPI operation, UP parameters set for computing service}.

Upon assignment and configuration by CP entity 1 and CP entity 2 respectively, UP entity 1 and UP entity 2 determine how/when to perform the communication UP task 3 and computing UP task 4. UP entity 1 may establish a Data Transfer Tunnel 3 when necessary for exchanging Communication Service Data of UP task 3 with the neighbor UP entity 2. UP entity 1 may establish a Data Transfer Tunnel 4 when necessary for exchanging Computing Service Data of UP task 4 with the neighbor UP entity 2. the UP entity 1 and UP entity 2 jointly perform the communication UP task 3 according to the configuration of UP parameters set for communication service, and may exchange the Communication Service Data of UP task 3 via the Data Transfer Tunnel 3. The UP entity 1 and UP entity 2 jointly perform the computing UP task 4 according to the configuration of UP parameters set for computing service, and may exchange the Computing Service Data of UP task 4 via the Data Transfer Tunnel 4. Afterwards, during the execution of two UP tasks, UP entity 1 and UP entity 2 can individually report and update the progress/status/result of UP task 3 or UP task 4 with the CP entity 1 and CP entity 2 respectively, via the E1AP signaling procedure. CP entity 1 and CP entity 2 may also reconfigure the UP entity 1 and UP entity 2 individually.

In a third example embodiment as in FIG. 7, the CU entity communicates via the F1 signaling procedure with two UP entities in DU. For this example, the UP task identifications are configured with a service type of communication service for UP task identification 5 and a service type of intelligence service for UP task identification 6. Further, the UP entities here may be distributed units (DU) rather than a centralized unit (CU). The UP entities in DU are both capable of performing or executing UP tasks of communication and intelligence service type (e.g. both UP entities can transfer user data and execute particular AI model training operations with the incoming packets from either UP entity). For a distributed AI model training with different sampling data set, the CP entity may let UP entity 1 and UP entity 2 perform the intelligence UP task jointly. UP entity 1 and UP entity 2 may perform the communication UP task jointly in parallel (e.g. they exchange/transfer the DRB packets of user data from UP entity).

As the coordinating/controlling node, the CP entity assigns and configures the UP entity 1 and UP entity 2 individually via F1AP signaling procedure. The configuration may include the following parameters for two UP tasks of different service types:
{UP Task id=5, Service Type=communication, transfer user data, UP parameters set for communication service};
{UP Task id=6, Service Type=intelligence, AI model training, UP parameters set for intelligence service}.

Upon assignment and configuration by the CP entity in CU, UP entity 1 and UP entity 2 in DU determine when/how to perform the communication UP task 5 and intelligence UP task 6 as indicated by the CP entity. UP entity 1 may establish a Data Transfer Tunnel 5 when necessary for exchanging Communication Service Data of UP task 5 with the neighbor UP entity 2. UP entity 1 may establish a Data Transfer Tunnel 6 for exchanging Intelligence Service Data of UP task 6 with the neighbor UP entity 2. The UP entity 1 and UP entity 2 jointly perform the communication UP task 5 according to the configuration of UP parameter set for communication service, and may exchange the communication service data of UP task 5 via the Data Transfer Tunnel 5. UP entity 1 and UP entity 2 jointly perform the intelligence UP task 6 according to the configuration of UP parameters set for intelligence service, and may exchange the Intelligence Service Data of UP task 6 via the Data Transfer Tunnel 6. Afterwards, during the execution of two UP tasks, UP entity 1 and UP entity 2 can individually report and update the progress/status/result of UP task 5 or UP task 6 with the CP entity via F1AP signaling procedure. CP entity may also reconfigure the UP entity 1 and UP entity 2 individually.

In a fourth example embodiment as in FIG. 7, the CU entity is a gNB/basestation/xNB entity, which communicates via the Uu air interface with two UP entities in UE. For this example, the UP task identifications are configured with a service type of communication service for UP task identification 7 and a service type of security service for UP task identification 8. The UP entity 1 and UP entity 2 are both capable of performing or executing UP tasks of communication and security service type (e.g. both UEs can transfer user data and execute particular data security protection operation with the incoming packets). In this example, the CP entity may be the basestation/gNB/xNB and the UP entities may be user equipment (UE). With UE's as UP entities, the communication may be via RRC. For the distributed data security protection with different backup set, CP entity may let UP entity 1 and UP entity 2 perform the security UP task jointly. UP entity 1 and UP entity 2 determine when/how to perform the communication UP task jointly in parallel (e.g. they exchange/transfer the packets of user data from the CU entity or basestation/gNB/xNB).

As the coordinating/controlling node, the CU entity (e.g. basestation/gNB/xNB) assigns and configures the UP entity 1 and UP entity 2 in UE individually via RRC signaling procedure. The configuration includes the following parameters for two UP tasks of different service types:
{UP Task id=7, Service Type=communication, transfer user data, UP parameters set for communication service};
{UP Task id=8, Service Type=security, distributed data protection, UP parameters set for security service}.

Upon assignment and configuration by the CU entity, UP entity 1 and UP entity 2 in UE determine when/how to perform the communication UP task 7 and security UP task 8. UP entity 1 may establish a Sidelink Tunnel 7 when necessary for exchanging Communication Service Data of UP task 7 with the neighbor UP entity 2. UP entity 1 may establish a Sidelink Tunnel 8 for exchanging Security Service Data of UP task 8 with the neighbor UP entity 2. The UP entity 1 and UP entity 2 jointly perform the communication UP task 7 according to the configuration of UP parameters set for communication service, and may exchange the Communication Service Data of UP task 7 via the Sidelink Tunnel 7. The UP entity 1 and UP entity 2 jointly perform the security UP task 8 according to the configuration of UP parameters set for security service, and may exchange the Security Service Data of UP task 8 via the Sidelink Tunnel 8. Afterwards, during the execution of two UP tasks, UP entity 1 and UP entity 2 can individually report and update the progress/status/result of UP task 7 or UP task 8 with the CU entity or basestation/gNB/xNB via RRC signaling procedure. The CU entity or basestation/gNB/xNB may also reconfigure the UP entity 1 and UP entity 2 individually.

The following is a list of abbreviations:

TABLE 1
Abbreviations.

| Abbreviation | Term |
|---|---|
| 5G | Fifth Generation |
| QoS | Quality of Service |
| LTE | Long Term Evolution |
| EPC | Evolved Packet Core |
| NR | New Radio |
| AMF | Access Mobility Function |
| SMF | Session Management Function |
| UPF | User Plane Function |
| CU | Centralized Unit |
| DU | Distributed Unit |
| RU | Radio Unit |
| CP | Control Plane |
| UP | User Plane |
| PDCP | Packet Data Convergence Protocol |
| MAC | Medium Access Control |
| DCI | Downlink Control Information |
| eMBB | enhanced Mobile Broadband |
| MN | Master node |
| SN | Secondary node |
| MCG | Master Cell Group |
| SCG | Secondary Cell Group |
| RRC | Radio Resource Control |
| Uu-C | Uu- Control Plane |
| Uu-U | Uu- User Plane |
| NG-C | Next Generation- Control Plane |
| NG-U | Next Generation- User Plane |
| Xn-C | Xn- Control Plane |
| Xn-U | Xn - User Plane |
| SIB | System Information Block |
| TCP | Transmission Control Protocol |

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method for wireless communication comprising:
configuring the extended user plane (UP) functions that support multiple services; and
initiating the execution of UP functions based on the configuring towards UP entity.

2. The method of claim 1, wherein
the UP functions comprise identifying a service type, UP task identification, and executing the functions for multiple service(s) based on the UP configuration(s);
or,
the multiple services comprises at least two of a communication service, computing service, intelligence service, storage service, and/or security service services.

3. (canceled)

4. The method of claim 1, wherein the configuring and the transmitting of UP configuration(s) is by network entity that comprises a control plane (CP) entity.

5. The method of claim 4, wherein the UP configuration(s) is received at the UP entity from the CP entity.

6. The method of claim 5, wherein
the configuring is through internal signaling or interface based signaling;
or,
the UP entity reports and updates a status or result for execution of the task(s) with the CP entity through internal signaling or an interface based signaling procedure.

7. The method of claim 5, wherein the configuring comprises UP configuration(s) of multiple services for one or multiple user plane (UP) entities.

8. The method of claim 7, further comprising:
synchronizing and coordinating the multiple services across the multiple UP entities.

9. The method of claim 8,
wherein the method further comprises:
allocating a task identification for the synchronizing and coordinating the multiple services across the multiple UP entities;
or,
the multiple UP entities are configured to exchange service data for different service types through different data transfer tunnels between the multiple UP entities.

10. (canceled)

11. (canceled)

12. A method for wireless communication comprising:
reporting the capabilities for multiple services within user plane (UP) entity; and
receiving an UP configuration(s) for the supported multiple services.

13. The method of claim 12, wherein the UP functions comprise identifying a service type, UP task identification, and executing functions for the multiple service(s) based on the UP configuration(s);
or,
the multiple services comprises at least two of a communication service, computing service, intelligence service, storage service, and/or security service services.

14. (canceled)

15. The method of claim 12, wherein the reporting of capabilities and the receiving of UP configuration(s) is by network entity that comprises one or more user plane (UP) entities.

16. The method of claim 15, wherein the UP configuration is from a control plane (CP) entity, wherein the UP configuration is received at the one or more UP entities from the CP entity.

17. The method of claim 16, wherein
the UP configuration is through internal signaling or interface based signaling;
or,
the one or more UP entities are configured to exchange service data for different service types through different data transfer tunnels between the one or more UP entities;
or,
the UP entity reports and updates a status or result for execution of the task(s) with the CP entity through internal signaling or an interface based signaling procedure.

18. The method of claim 16, wherein the UP configuration(s) comprises the separate UP configuration of each service to be configured for one or more user plane (UP) entities.

19. The method of claim 18, wherein the UP configuration(s) comprises a synchronization and coordinating of the multiple services for one or more UP entities.

20. The method of claim 19, wherein the UP configuration(s) comprises a task identification for the synchronization and coordinating of the multiple services across the one or more UP entities.

21. (canceled)

22. (canceled)

23. A wireless communications apparatus comprising a processor and a memory, wherein the processor is configured to read code from the memory and implement a method recited in claim 1.

24. A computer program product comprising a computer-readable program medium code stored thereupon, the code, when executed by a processor, causing the processor to implement a method recited in claim 1.

25. A wireless communications apparatus comprising a processor and a memory, wherein the processor is configured to read code from the memory and implement a method recited in claim 12.

26. A computer program product comprising a computer-readable program medium code stored thereupon, the code, when executed by a processor, causing the processor to implement a method recited in claim 12.
